(19) United States
(12) Patent Application Publication
(10) Pub. No.: US 2008/0104645 A1
(43) Pub. Date: May 1, 2008

(54) Contents receiving unit and picture recording unit, reproducing unit and receiving unit

(76) Inventor: Mao KISHIMOTO, Osaka (JP)

Correspondence Address: MCDERMOTT WILL & EMERY LLP, 600 13TH STREET, NW, WASHINGTON, DC, 20005-3096, US

(21) Appl. No.: 11/976,355

(22) Filed: Oct. 24, 2007

(30) Foreign Application Priority Data
Oct. 30, 2006 (JP) 2006-294064

(51) Int. Cl. H04N 7/173

(52) U.S. Cl. 725/97; 725/90

(57) ABSTRACT

A contents receiving unit includes a contents receiving section for receiving contents; a contents information storing section for storing contents information of contents received by the contents receiving section; a duplicated contents discriminating section for determining whether or not content to be newly received by the contents receiving section accords with any of previously received contents by referring to the contents information stored in the contents information storing section; and a processing section for executing processing on the content to be newly received in accordance with a discrimination result obtained by the duplicated contents discriminating section.

### CROSS-REFERENCE TO RELATED APPLICATIONS

This application claims priority under 35 U.S.C. §119 on Patent Application No. 2006-294064 filed in Japan on Oct. 30, 2006, the entire contents of which are hereby incorporated by reference.

### BACKGROUND OF THE INVENTION

The present invention relates to a contents receiving unit for receiving contents, and a picture recording unit, a reproducing unit and a receiving unit.

In accordance with the recent expansion of the broadband service, a service in which a provider delivers contents so that a user can receive the contents for picture recording/storing/reproducing has been rapidly spread. As a system used in such a service, there are a system in which a provider stores contents in a contents server so that a user can receive a content file of desired content from the contents server to be stored and a system in which a provider stores contents in a contents server as stream data so that a user can receive desired stream data from the contents server to be reproduced.

Furthermore, there are not only a system in which a user positively acquires contents in the aforementioned manner but also a system in which the opportunity for a user to acquire contents is increased by repeatedly delivering the same contents as in the CS or CATV.

Since the opportunity for a user to acquire contents by such a variety of systems is increasing, control/management for avoid duplicated acquirement of the same content is a significant problem.

As a conventionally known system for managing/controlling such duplication in acquiring contents, as described in, for example, Japanese Laid-Open Patent Publication No. 2003-58450, a user is identified by a provider for delivering contents, so that when a content acquirement request is issued by a user, it can be determined whether or not the content requested for the acquirement has been previously acquired by the user.

In the technique described in Japanese Laid-Open Patent Publication No. 2003-58450, when a content acquirement request is issued by a user, it is determined whether or not the content has been previously acquired by the user, and when it is determined that the content has been previously acquired, a Web page for confirming re-acquirement is displayed so as to inform the user that it may be unnecessary acquirement.

### SUMMARY OF THE INVENTION

In the technique described in Japanese Laid-Open Patent Publication No. 2003-58450, however, it is determined whether or not the content requested for the acquirement has been previously acquired on the side of a provider, namely, by a contents server. Therefore, in the case where the acquirement request is issued to a provider different from that previously requested or in the case where contents are delivered without management of receipt of contents by a user as in the CS or CATV, it is impossible to manage/control the duplication of contents acquired by a user.

Furthermore, in the case where contents are delivered in a network in which there is no hierarchical relationship among computers connected to one another without distinguishing the relationship between a provider and a user as in the Peer-to-Peer network, there is no concept of a provider. Therefore, it is impossible to manage/control the duplication of contents acquired by a user.

The present invention was devised in consideration of the aforementioned problem, and an object of the invention is providing a contents receiving unit, and a picture recording unit, a reproducing unit and a receiving unit in which a user can manage/control acquired contents for avoiding duplicated acquirement even when the user is to acquire content previously acquired.

In order to achieve the object, in the contents receiving unit for receiving contents according to the present invention, it is determined whether or not content to be newly received accords with any of previously acquired contents.

The contents receiving unit according to a first aspect of the invention includes a contents receiving section for receiving contents; contents information storing section for storing contents information of contents received by the contents receiving section; a duplicated contents discriminating section for determining whether or not content to be newly received by the contents receiving section accords with any of previously received contents by referring to the contents information stored in the contents information storing section; and a processing section for executing processing on the content to be newly received in accordance with a discrimination result obtained by the duplicated contents discriminating section.

Thus, in the case where it is determined that content to be newly received accords with any of the previously received contents by the duplicated contents discriminating section, processing can be performed so that, for example, the processing section can output a screen for selecting termination of the new receipt of the content. Accordingly, duplication of contents to be acquired can be managed/controlled by the contents receiving unit, namely, on the side of a user.

The contents receiving unit according to a second aspect of the invention includes a contents receiving section for receiving contents; a contents recording section for recording contents received by the contents receiving section in a data storing device; a duplicated contents searching/discriminating section for determining whether or not content to be newly received by the contents receiving section accords with any of previously recorded contents by searching contents stored in the data storing device; and a processing section for executing processing on the content to be newly received in accordance with a discrimination result obtained by the duplicated contents searching/discriminating section.

Thus, even when contents information of previously received contents is not stored in the contents receiving unit, the duplicated contents searching/discriminating unit can determine whether or not content to be newly received accords with any of previously recorded contents by searching the contents stored in the data storing device. Accordingly, without using contents information of received contents, the duplication of contents to be acquired can be managed/controlled by the contents receiving unit.

The contents receiving unit according to a third aspect of the invention includes the contents receiving unit of the first aspect and the contents receiving unit of the second aspect.

Thus, the duplication management performed by using contents information and the duplication management performed by using contents stored in the data storing device can be both employed, so that contents to be acquired can be more accurately managed/controlled by the contents receiving unit.

### BRIEF DESCRIPTION OF THE DRAWINGS

FIG. 1 is a block diagram for showing the whole architecture of a contents receiving unit 100 according to Embodiment 1 of the invention.

FIG. 2 is a flowchart of processing performed in the contents receiving unit 100.

FIG. 3 is a block diagram for showing the whole architecture of a contents receiving unit 300 according to a modification of Embodiment 1.

FIG. 4 is a block diagram for showing the whole architecture of a contents receiving unit 400 according to Embodiment 2 of the invention.

FIGS. 5A, 5B and 5C are schematic diagrams for showing a discrimination process for reservation for re-recording performed in the contents receiving unit 400.

FIG. 6 is a block diagram for showing the whole architecture of a contents receiving unit 600 according to Embodiment 3 of the invention.

FIG. 7 is a block diagram for showing the whole architecture of a contents receiving unit 700 according to Embodiment 4 of the invention.

FIG. 8 is a flowchart of processing performed in the contents receiving unit 700.

FIG. 9 is a block diagram for showing the whole architecture of a contents receiving unit 900 according to Embodiment 5 of the invention.

FIG. 10 is a flowchart of processing performed in the contents receiving unit 900.

FIG. 11 is a block diagram for showing the whole architecture of a contents receiving unit 1100 according to Embodiment 6 of the invention.

FIG. 12 is a flowchart of processing performed in the contents receiving unit 1100.

FIG. 13 is a block diagram for showing the whole architecture of a contents receiving unit 1300 according to Embodiment 7 of the invention.

FIG. 14 is a flowchart of processing performed in the contents receiving unit 1300.

FIG. 15 is a block diagram for showing the whole architecture of a contents receiving unit 1500 according to Embodiment 8 of the invention.

FIG. 16 is a flowchart of processing performed in the contents receiving unit 1500.

FIG. 17 is a block diagram for showing the whole architecture of a contents receiving unit 1700 according to Embodiment 9 of the invention.

### DETAILED DESCRIPTION OF THE INVENTION

Now, contents receiving units according to preferred embodiments of the invention will be described with reference to the accompanying drawings.

### Embodiment 1

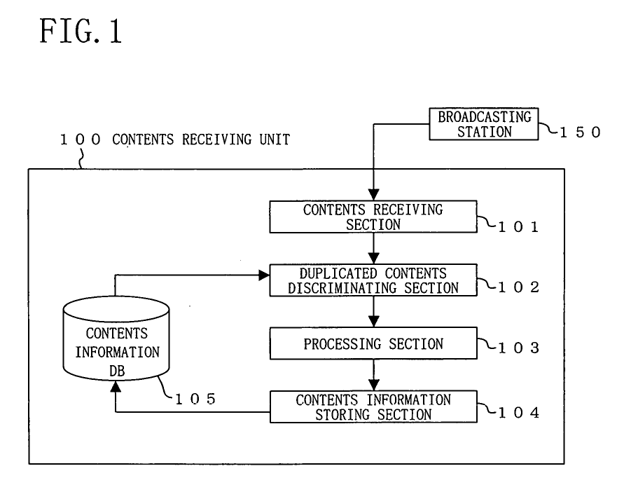

FIG. 1 is a block diagram for showing the whole architecture of a contents receiving unit 100 according to Embodiment 1 of the invention.

As shown in FIG. 1, the contents receiving unit 100 includes a contents receiving section 101, a duplicated contents discriminating section 102, a processing section 103, a contents information storing section 104 and a contents information DB 105.

The contents receiving section 101 receives contents from a broadcasting station 150. The contents receiving section 101 is suitably radio communication means but may be wire communication means. Also, it may receive contents not only from the broadcasting station 150 but also from a contents server through the internet.

The contents information storing section 104 stores contents information of contents received by the contents receiving section 101 in the contents information DB 105. In this case, the contents information is information for specifying content such as the program title of a delivered program, a content ID provided to each content, a file size of a content file holding the content and a file name of a content file holding the content. Although the contents information is stored in the contents information DB 105 in this embodiment, the contents information may be stored in a nonvolatile or volatile recording medium provided in the contents information storing section 104.

The duplicated contents discriminating section 102 determines whether or not content to be newly received by the contents receiving section 101 accords with any of previously received contents by referring to the contents information stored in the contents information DB 105. In this discrimination, it is determined whether or not the content to be newly received accords with any of previously received contents on the basis of, for example, the program title of a delivered program, the content ID, the file size of the content file, the file name of the content file or the like.

Specifically, in the case where a part of the contents information of the content to be newly received accords with a part of the contents information stored in the contents information DB 105, it is determined that the content to be newly received has been previously received. Alternatively, in the case where at least one of words included in the contents information of the content to be newly received accords with a part of the contents information stored in the contents information DB 105, it is determined that the content to be newly received has been previously received. Moreover, any of these discrimination methods may be combined.

The duplicated contents discriminating section 102 is realized by using an MPU, a memory or the like, and processing performed therein is realized in accordance with software recorded in a recording medium such as a ROM. Alternatively, the discrimination process may be performed by using hardware with a dedicated circuit provided.

The processing section 103 processes the content to be newly received by the contents receiving section 101 in accordance with the discrimination result obtained by the duplicated contents discriminating section 102. In the case where the duplicated contents discriminating section 102 determines that the newly received content has been previously received, the processing section 103 terminates the receipt of the new content by the contents receiving section 101.

The processing section 103 is realized by using an MPU, a memory or the like, and the processing performed therein is realized in accordance with software recorded in a recording medium such as a ROM. Alternatively, the processing may be performed by using hardware with a dedicated circuit provided.

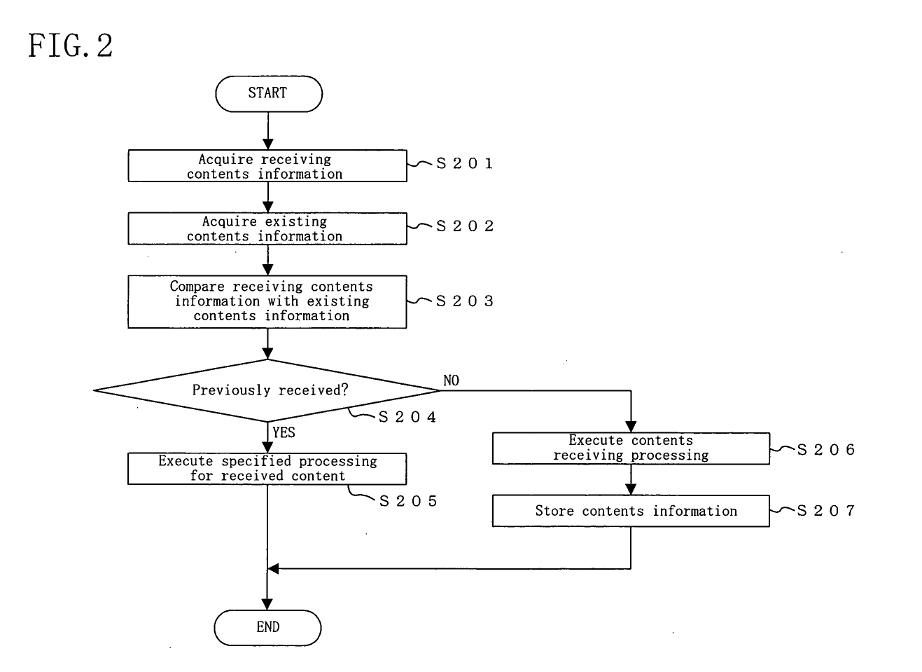

FIG. 2 is a flowchart of processing performed in the contents receiving unit 100 of this embodiment.

First, the contents receiving section 101 acquires contents information of content to be received (receiving contents information) (step S201). Next, the duplicated contents discriminating section 102 acquires contents information of previously received contents (existing contents information) from the contents information DB 105 (step S202), and compares the receiving contents information with the existing contents information (step S203).

In the comparison of the contents information performed by the duplicated contents discriminating section 102 in step S203, the program title of a delivered program, a content ID, a file size of a content file, a file name of a content file or the like is used. Specifically, in the case where a part of the receiving contents information accords with a part of the existing contents information or in the case where at least one of words included in the contents information, such as words included in the program title, accords with that included in the existing contents information, it is determined that the content to be newly received accords with previously received content.

In the case where it is determined by the duplicated contents discriminating section 102 that the content to be newly received by the contents receiving section 101 accords with any of previously received contents (step S204), the processing section 103 executes specified processing for received content (step S205).

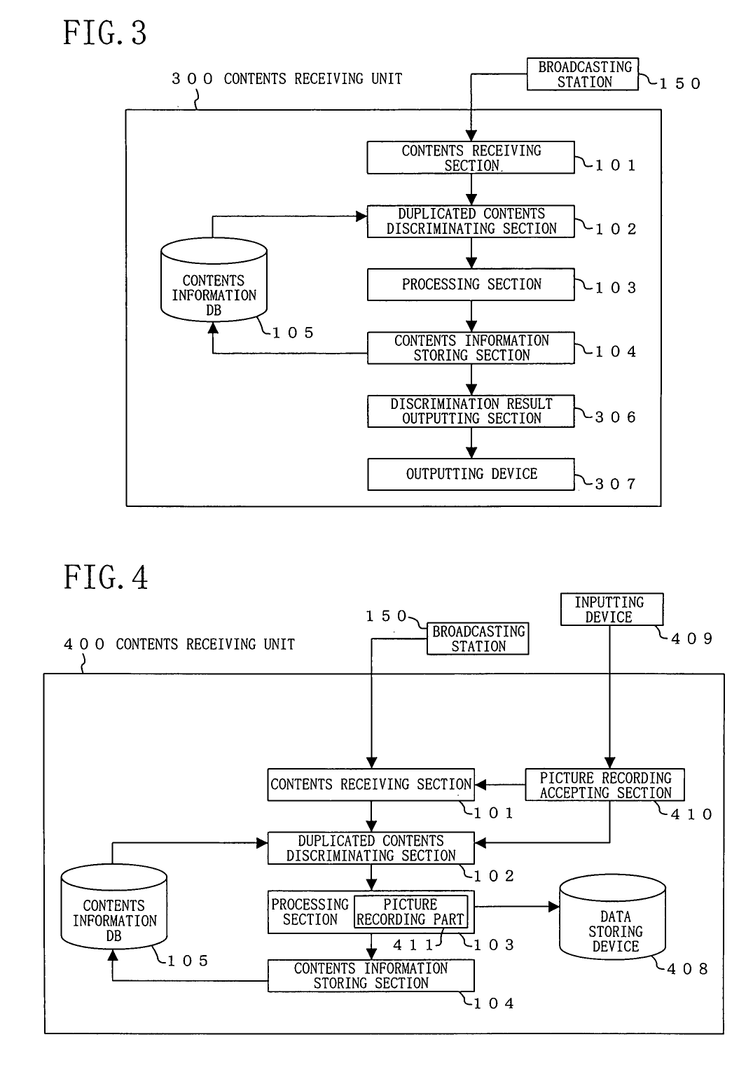

In this specified processing, for example, the discrimination result obtained by the duplicated contents discriminating section 102 is output to an output device, or the receipt of the content by the contents receiving section 101 is terminated. Alternatively, as shown in FIG. 3, a contents receiving unit 300 may further include a discrimination result outputting section 306 for outputting, to an outputting device 307, the discrimination result obtained by the duplicated contents discriminating section 102 or a screen for selecting termination of the receipt, so that a user can select whether or not the receipt of the content is terminated. When termination is selected on the screen, the processing section 103 terminates receipt of the content.

In the case where it is determined by the duplicated contents discriminating section 102 that the content to be newly received does not accord with any of previously received contents (step S204), the processing section 103 executes contents receiving processing, so as to receive the content by the contents receiving section 101 (step S206). Thereafter, the contents information storing section 104 stores contents information of the newly received content in the contents information DB 105 (step S207).

In the procedures of step S202 and step S203 of the flowchart of FIG. 2, while repeatedly partly acquiring the existing contents information, the receiving contents information may be compared every time the existing contents information is partly acquired. Furthermore, if there occurs interruption such as power off or processing termination, such a series of contents receiving processing is ended.

In this manner, according to this embodiment, it is determined by the duplicated contents discriminating section 102 that content to be newly received by the contents receiving section 110 accords with any of previously received contents, and when it is determined that the new content accords with any of previously received contents, the new receipt of the content is terminated. Therefore, duplication of contents can be managed/controlled by the contents receiving unit, namely, on the side of a user.

Also, as shown in FIG. 3, when the discrimination result outputting section 306 informs a user of the discrimination result obtained by the duplicated contents discriminating section 102 through the output device 307, the user can recognize that the content is or may be duplicated and can select whether or not the new receipt is terminated.

The processing operation of the contents receiving unit of this embodiment may be realized by using software, and the software may be delivered through software download or by using a recording medium such as a CD-ROM.

### Embodiment 2

FIG. 4 is a block diagram for showing the whole architecture of a contents receiving unit according to Embodiment 2 of the invention.

The contents receiving unit 400 of this embodiment is different from the contents receiving unit 100 of Embodiment 1 shown in FIG. 1 in including a picture recording accepting section 410 and a data storing device 408 and in the processing section 103 including a picture recording part 411. The rest of the architecture is the same as that described in Embodiment 1 and hence the description is omitted.

In the architecture of FIG. 4, a user gives instruction to the picture recording accepting section 410 to perform picture recording reservation or picture recording by using an input device 409. The input device 409 is a remote controller, a mouse, a keyboard, a touch panel, a voice input device or the like, and is used for inputting an instruction of a user to the contents receiving unit 400. The picture recording accepting section 410 is a device driver for the input device such as a key board, control software for a menu screen or the like, and accepts the instruction of the picture recording reservation or the picture recording input to the input device 409.

The picture recording part 411 records contents received by the contents receiving section 101 in the data storing device 408 in accordance with the instruction of the picture recording reservation or the picture recording accepted by the picture recording accepting section 410. The picture recording part 411 is realized by using an MPU, a memory or the like, and the processing performed therein is realized in accordance with software recorded in a recording medium such as a ROM. Alternatively, the processing may be performed by using hardware with a dedicated circuit provided.

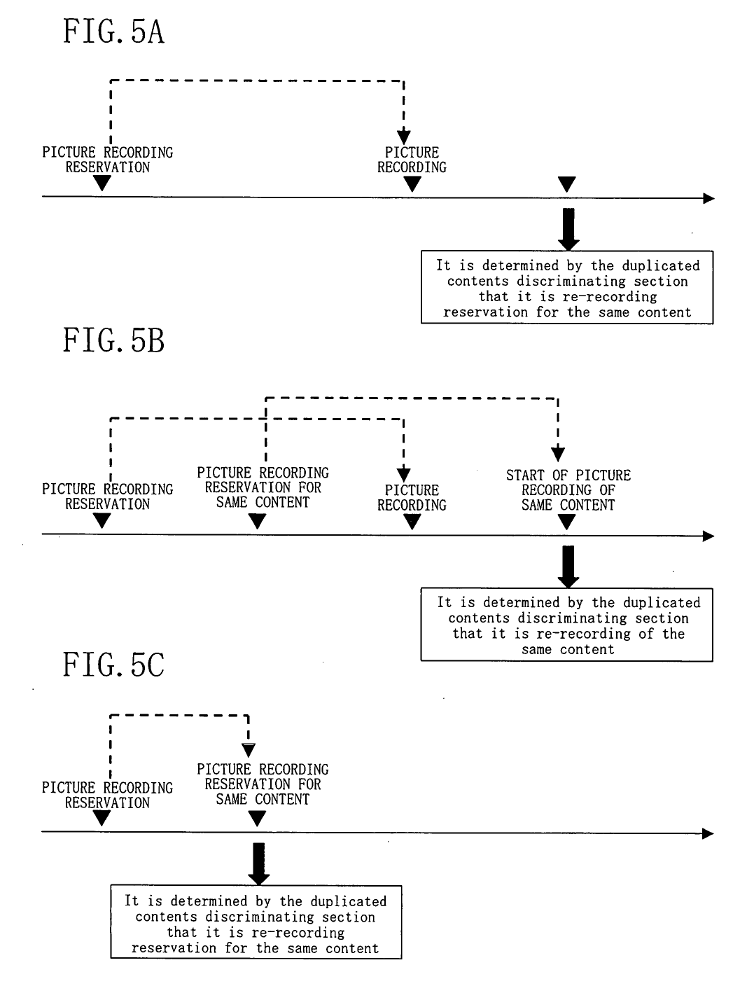

Now, the processing operation performed by the contents receiving unit 400 of this embodiment will be described with reference to FIGS. 4 and 5A through 5C.

First, when a user makes an instruction of picture recording reservation or picture recording by using the input device 409, the instruction of the picture recording reservation or picture recording is accepted by the picture recording accepting section 410. In accepting the instruction of the picture recording reservation or picture recording, the contents receiving section 101 acquires contents information of content to be newly received for recording (receiving contents information).

Thereafter, the duplicated contents discriminating section 102 acquires contents information of previously recorded contents (existing contents information) from the contents information DB 105 and compares the receiving contents information with the existing contents information. In the case where it is determined by the duplicated contents discriminating section 102 that the content newly instructed for the picture recording reservation or picture recording accords with any of previously recorded contents, the picture recording part 411 executes specified processing for recorded content.

In this specified processing, for example, the discrimination result obtained by the duplicated contents discriminating section 102 is output so as to terminate the picture recording reservation or picture recording. Alternatively, as shown in FIG. 3, the contents receiving unit 400 may further include a discrimination result outputting section 306 for outputting, to the outputting device 307, a screen on which termination of the picture recording reservation or picture recording may be selected, so that a user can select whether or not the picture recording is terminated. When the user selects termination of the picture recording, the processing section 103 terminates the picture recording. It is noted that outputting is performed in this case by displaying on a display device, printing by a printer, speech output, transmittance to an external device or the like.

Furthermore, in the contents receiving unit 400, when the picture recording part 411 starts the recording of the content having been reserved for the picture recording, the contents receiving section 101 acquires the receiving contents information again, and the duplicated contents discriminating section 102 compares the receiving contents information with the existing contents information again. In the case where it is determined, as a result of the comparison by the duplicated contents discriminating section 102, that the content to be newly recorded accords with any of previously recorded contents, the processing section 103 executes the specified processing for recorded content.

When it is determined by the duplicated contents discriminating section 102 that the content to be newly recorded does not accord with any of previously recorded contents, the picture recording part 411 starts the picture recording so as to store the content in the data storing device 408. Then, the contents information storing section 104 stores the contents information of the recorded content in the contents information DB 105. Although the contents information is stored in the contents information DB 105 in this embodiment, the contents information may be stored in a nonvolatile or volatile recording medium provided in the contents information storing section 104.

Furthermore, in the contents receiving unit 400 of this embodiment, the contents information of content reserved for picture recording may be once stored in the duplicated contents discriminating section 102, so that the thus stored contents information can be compared with the receiving contents information for determining whether or not the content reserved for picture recording accords with any of contents previously reserved for picture recording. In this case, when it is determined that the content newly reserved for picture recording accords with any of contents previously reserved for picture recording, the processing section 103 executes processing similar to the specified processing for recorded content.

FIGS. 5A through 5C are schematic diagrams for showing discrimination processes for reservation for re-recording performed in the contents receiving unit 400.

In FIGS. 5A through 5C, it is assumed that content reserved for picture recording and content to be reserved for re-recording are the same content but are different in time of broadcasting or delivery.

FIG. 5A shows a discrimination process performed when previously recorded content is to be re-recorded, in which the specified processing for recorded content is executed when the re-recording is reserved.

FIG. 5B shows a discrimination process performed when the same content is reserved for re-recording before recording content reserved for the picture recording, in which the specified processing for recorded content is executed when the same content is to be recorded in duplicate.

FIG. 5C shows a discrimination process performed when the same content is reserved for re-recording before recording content reserved for the picture recording, in which the specified processing for content reserved for the picture recording is executed when the same content is reserved for recording.

In this manner, according to this embodiment, it is determined by the duplicated contents discriminating section 102 whether or not content to be newly recorded by the picture recording part 411 accords with any of previously recorded contents or contents previously reserved for picture recording. When it is determined that the content accords with any of contents previously recorded or previously reserved for picture recording, the new picture recording is terminated, so that the duplication of contents to be recorded can be managed/controlled by the contents receiving unit, namely, on the side of a user.

### Embodiment 3

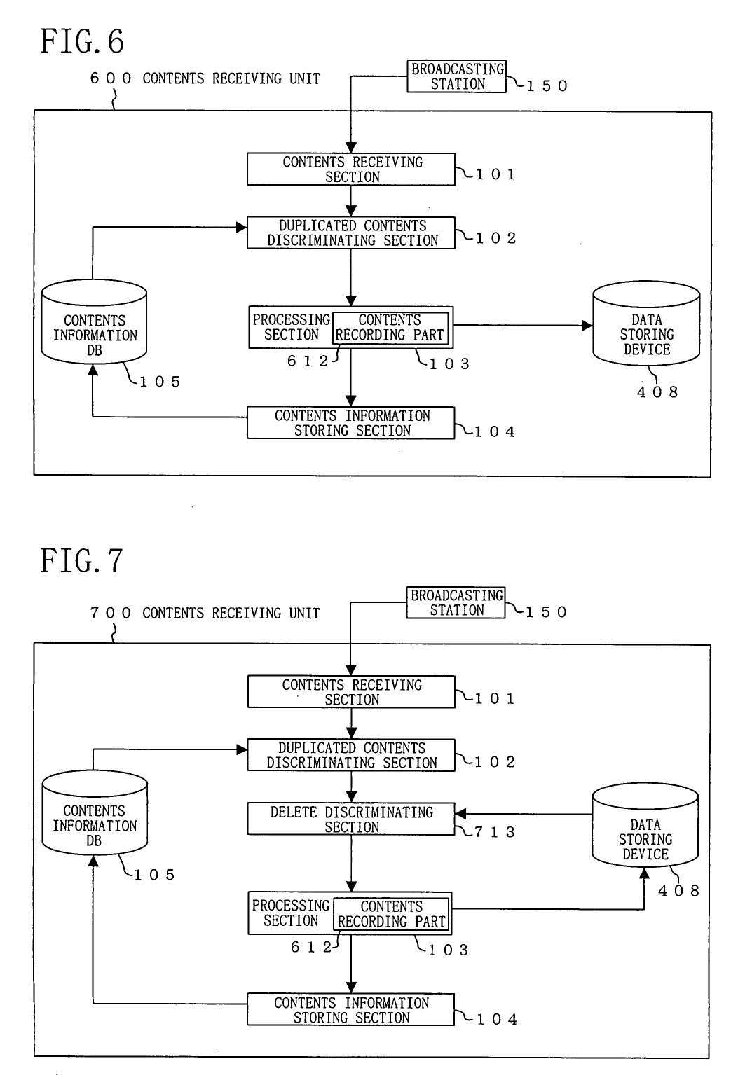

FIG. 6 is a block diagram for showing the whole architecture of a contents receiving unit according to Embodiment 3 of the invention.

The contents receiving unit 600 of this embodiment is different from the contents receiving unit 100 of Embodiment 1 shown in FIG. 1 in including a data storing device 408 and in the processing section 103 including a contents recording part 612. The rest of the architecture is the same as that of Embodiment 1 and hence the description is omitted.

In the architecture of FIG. 6, the contents recording part 612 records contents received by the contents receiving section 101 in the data storing device 408.

In this embodiment, when content is received, the contents receiving section 101 downloads a content file holding the content and the contents recording part 612 records the content file in the data storing device 408.

Now, the processing operation performed in the contents receiving unit 600 of this embodiment will be described with reference to FIG. 6.

First, the contents receiving section 101 acquires contents information of content to be newly downloaded (receiving contents information). Next, the duplicated contents discriminating section 102 acquires contents information of contents previously downloaded (existing contents information) from the contents information DB 105 and compares the receiving contents information with the existing contents information.

When it is determined by the duplicated contents discriminating section 102 that the content to be newly downloaded by the contents receiving section 101 accords with any of previously downloaded contents, the processing section 103 executes specified processing for downloaded content. In this specified processing, for example, the discrimination result obtained by the duplicated contents discriminating section 102 is output to an output device for terminating the download. Alternatively, as shown in FIG. 3, a discrimination result outputting section 306 may be further provided for outputting, to an outputting device 307, a screen for selecting whether or not the downloaded content is re-downloaded, so that a user can select whether or not the download is terminated.

When it is determined by the duplicated contents discriminating section 102 that the content to be newly downloaded does not accord with any of previously downloaded contents, the contents receiving section 101 downloads the content and the contents recording part 612 stores the downloaded content in the data storing device 408. Thereafter, the contents information storing section 104 stores contents information of the newly downloaded content in the contents information DB 105.

In this manner, according to this embodiment, it is determined by the duplicated contents discriminating section 102 whether or not content to be newly received and downloaded by the contents receiving section 101 accords with any of previously downloaded contents, and when it is determined that the content accords with any of previously downloaded contents, the new download of the content is terminated. Therefore, the duplication of contents to be downloaded can be managed/controlled by the contents receiving unit.

Furthermore, when a content file is newly downloaded in network equipment such as a personal computer or a cellular phone, if a previously downloaded content file is to be re-downloaded, it can be conventionally downloaded to a different location and hence the duplicated storage cannot be avoided. In this embodiment, however, even when a new content file is to be stored in a location different from a previously downloaded location, the duplicated contents discriminating section 102 refers to the existing contents information stored in the contents information DB 105 so as to find that the new download is re-download, and therefore, the duplication of contents download can be prevented.

### Embodiment 4

FIG. 7 is a block diagram for showing the whole architecture of a contents receiving unit according to Embodiment 4 of the invention.

The contents receiving unit 700 of this embodiment is different from the contents receiving unit 600 of Embodiment 3 shown in FIG. 6 in further including a delete discriminating section 713. The rest of the architecture is the same as that of Embodiment 3 and hence the description is omitted.

When it is determined by the duplicated contents discriminating section 102 that content to be newly received for recording accords with any of previously recorded contents, the delete discriminating section 713 determines whether or not the recorded content has been deleted from the data storing device 408.

The delete discriminating section 713 is realized by using an MPU, a memory or the like, and the processing performed therein is realized in accordance with software recorded in a recording medium such as a ROM. Alternatively, the processing may be performed by using hardware with a dedicated circuit provided.

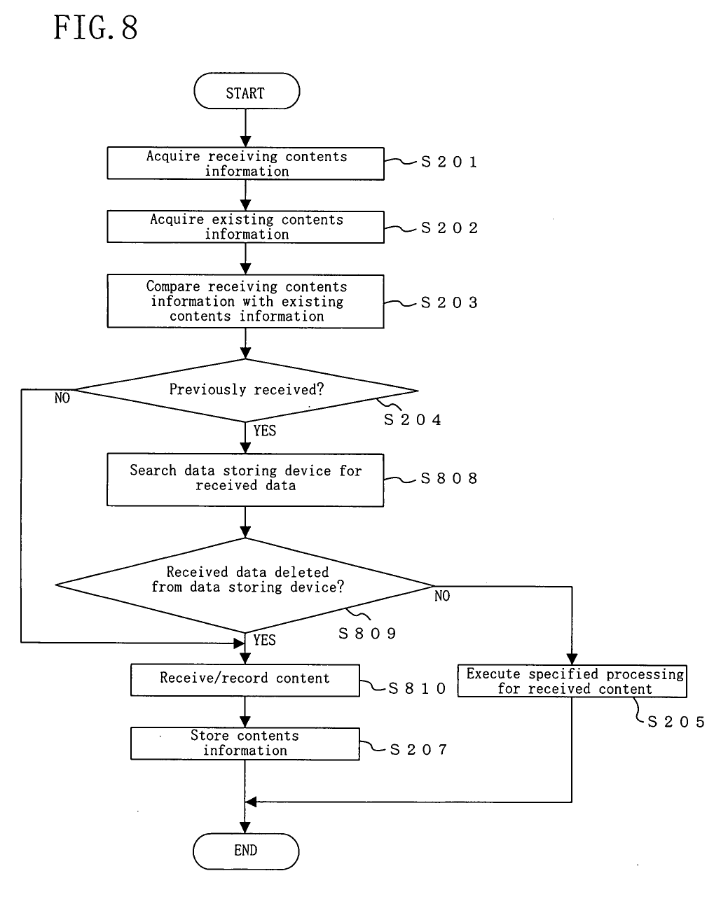

FIG. 8 is a flowchart of processing performed in the contents receiving unit 700 of this embodiment.

In FIG. 8, procedures performed in steps S201 through S203 are the same as those of Embodiment 1 shown in FIG. 2 and hence the description is omitted.

When it is determined by the duplicated contents discriminating section 102 that content to be newly received for recording by the contents receiving section 101 accords with any of previously recorded contents (step S204), the delete discriminating section 713 determines whether or not the recorded content is present in the data storing device 408 by searching the data storing device 408 for the recorded content (step S808). In the case where it is determined by the delete discriminating section 713 that the recorded contents has been deleted from the data storing device 408 (step S809), the content determined to have been recorded is received and recorded (step S810). Thereafter, the contents information storing section 104 stores contents information of the newly recorded content in the contents information DB 105 (step S207).

In the case where it is determined by the delete discriminating section 713 that the recorded content has not been deleted from the data storing device 408 (step S809), the processing section 103 executes specified processing for recorded content (step S205).

Furthermore, when it is determined by the duplicated contents discriminating section 102 that the content to be newly received for recording does not accord with any of previously recorded contents (step S204), contents receiving processing is performed so that the contents receiving section 101 can newly receive the content for recording (step S810). Thereafter, the contents information storing section 104 stores contents information of the newly recorded content in the contents information DB 105 (step S207).

As described above, in the case where any previously recorded content has been deleted, since the contents information of this deleted content still remains in the contents receiving unit, it is determined that the content has been previously received. However, even when the content has been previously received, if it is determined through the search of the data storing device 408 that the content has already been deleted, the content can be re-received and re-recorded.

Alternatively, when previously received and recorded content is deleted, the contents information of this content may be simultaneously deleted, so that the same effect as that of this embodiment can be attained.

Furthermore, in this embodiment, when content to be newly received is determined to accord with previously recorded content, the delete discriminating section 713 determines whether or not the recorded content has been deleted from the data storing device 408. Instead, when content to be newly received is determined to accord with previously received content, it may be determined whether or not the received content still remains in the data storing device 408.

### Embodiment 5

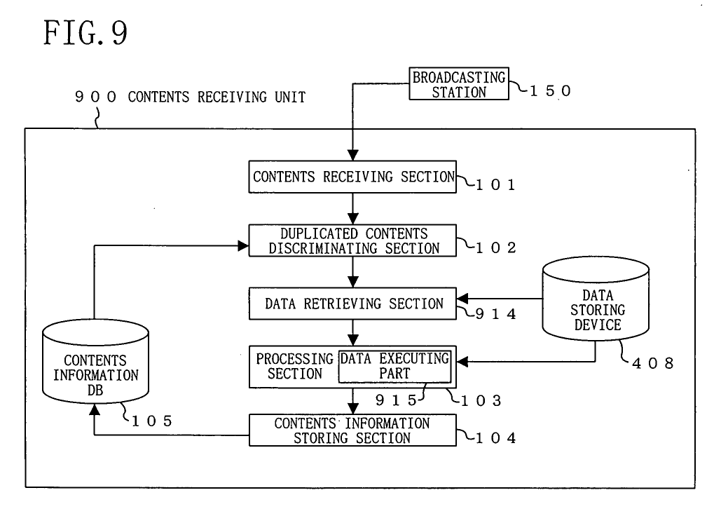

FIG. 9 is a block diagram for showing the whole architecture of a contents receiving unit according to Embodiment 5 of the invention.

The contents receiving unit 900 of this embodiment is different from the contents receiving unit 100 of Embodiment 1 shown in FIG. 1 in including a data storing device 408 and a data retrieving section 914 and in the processing section 103 including a data executing part 915. The rest of the architecture is the same as that of Embodiment 1 and hence the description is omitted.

In FIG. 9, the data storing device 408 stores recorded contents previously received by the contents receiving section 101.

When it is determined by the duplicated contents discriminating section 102 that content to be newly received by the contents receiving section 101 accords with any of previously recorded contents, the data retrieving section 914 retrieves the recorded content stored in the data storing device 408.

The data executing part 915 reproduces or executes the content retrieved by the data retrieving section 914. This content is the same as the content to be newly received by the contents receiving section 101.

Each of the data retrieving section 914 and the data executing part 915 is realized by using an MPU, a memory or the like, and the processing performed therein is realized in accordance with software recorded in a recoding medium such as a ROM. Alternatively, the processing may be performed by using hardware with a dedicated circuit provided.

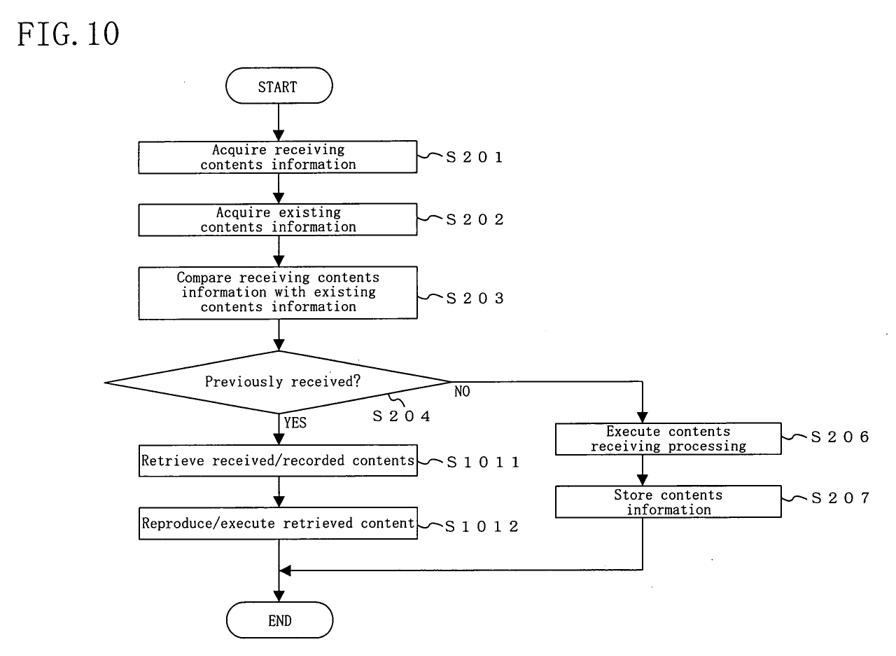

FIG. 10 is a flowchart of processing performed in the contents receiving unit 900 of this embodiment.

In FIG. 10, procedures performed in steps S201 through S203 are the same as those performed in Embodiment 1 shown in FIG. 2 and hence the description is omitted.

When it is determined by the duplicated contents discriminating section 102 that content to be newly received by the contents receiving section 101 accords with any of previously recorded contents, the data retrieving section 914 retrieves the recorded content stored in the data storing device 408 (step S1011). Thereafter, the data executing part 915 reproduces or executes the content retrieved by the data retrieving section 914 (step S1012).

When it is determined by the duplicated contents discriminating section 102 that the content to be newly received does not accord with any of previously recorded contents, the processing section 103 executes the content receiving processing so as to receive the new content (step S206). Thereafter, the contents information storing section 104 stores contents information of the newly received content in the contents information DB 105 (step S207).

In this manner, according to this embodiment, the data retrieving section 914 and the data executing part 915 are provided, and hence, in the case where content to be received by the contents receiving section 101 has been already stored in the data storing device 408, the desired content can be reproduced or executed without newly receiving the content.

Also, when a discrimination result outputting section 306 and an outputting device 307 are provided as in the contents receiving unit 300 shown in FIG. 3, a user can select whether or not the content is to be reproduced or executed by the data executing part 915.

Furthermore, in this embodiment, when content to be newly received is determined to accord with any of previously recorded contents, the data retrieving section 914 retrieves the recorded content stored in the data storing device 408. Instead, when content to be newly received is determined to accord with any of previously received contents, the received content may be retrieved in the data storing device 408.

### Embodiment 6

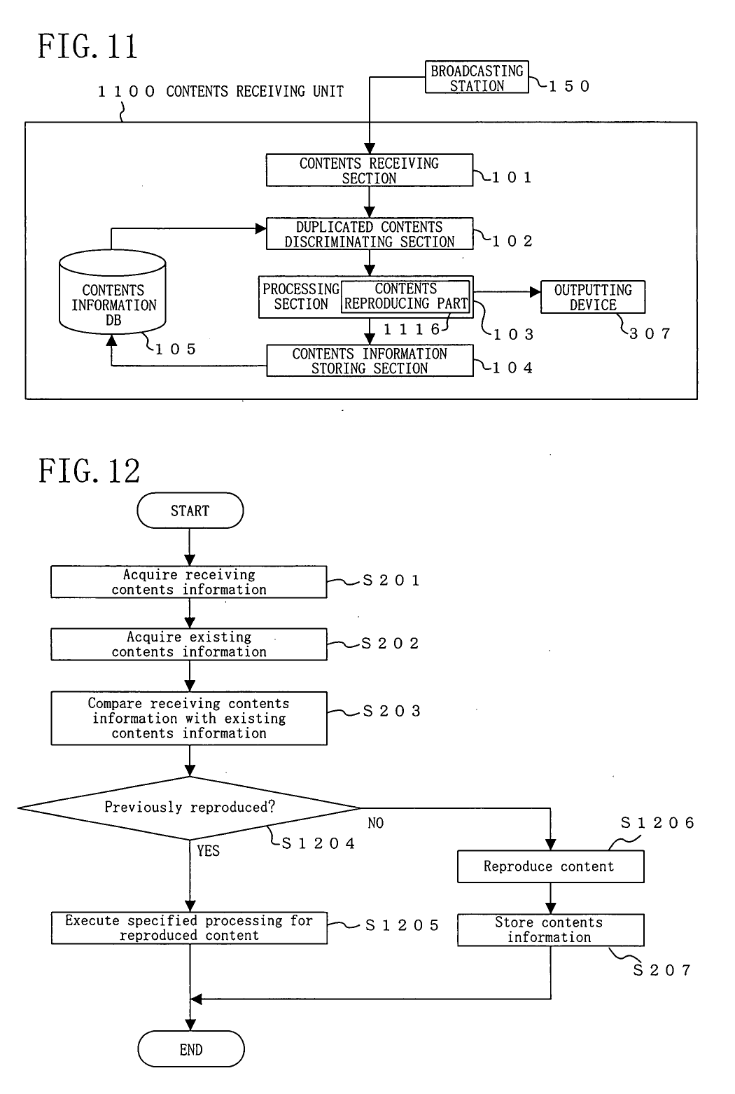

FIG. 11 is a block diagram for showing the whole architecture of a contents receiving unit according to Embodiment 6 of the invention.

The contents receiving unit 1100 of this embodiment is different from the contents receiving unit 100 of Embodiment 1 shown in FIG. 1 in including an outputting device 307 and in the processing section 103 including a contents reproducing part 1116. The rest of the architecture is the same as that of Embodiment 1 and hence the description is omitted.

In this embodiment, content to be received by the contents receiving section 101 is stream data, and the stream data received by the contents receiving section 101 is reproduced by the contents reproducing part 1116 to be displayed by the outputting device 307.

The contents reproducing part 1116 is realized by using an MPU, a memory or the like, and the processing performed therein is realized in accordance with software recorded in a recording medium such as a ROM. Alternatively, the processing may performed by using hardware with a dedicated circuit provided.

FIG. 12 is a flowchart of processing performed in the contents receiving unit 1100 of this embodiment.

First, the contents receiving section 101 acquires contents information of content to be received for reproducing (receiving contents information) (step S201). Next, the duplicated contents discriminating section 102 acquires contents information of previously received and reproduced contents (existing contents information) from the contents information DB 105 (step S202), and compares the receiving contents information with the existing contents information (step S203).

When it is determined by the duplicated contents discriminating section 102 that the content to be newly received for reproducing by the contents receiving section 101 accords with any of previously received and reproduced contents (step S1204), the processing section 103 executes specified processing for acquired content (step S1205). In this specified processing, for example, the discrimination result obtained by the duplicated contents discriminating section 102 is output to the outputting device 307, or the reproducing is terminated without allowing the contents receiving section 101 to receive the content.

When it is determined by the duplicated contents discriminating section 102 that the content to be newly received for reproducing does not accord with any of previously received and reproduced contents (step S1204), the contents receiving section 101 receives the content, and the contents reproducing part 1116 reproduces the received content to be displayed by the outputting device 307 (step S1206). Thereafter, the contents information storing section 104 stores contents information of the newly received and reproduced content in the contents information DB 105 (step S207).

In this manner, according to this embodiment, even in the case where content to be received by the contents receiving section 101 is stream data such as video on-demand, the duplicated contents discriminating section 102 discriminates whether or not the stream data to be newly received for reproducing accords with any of previously reproduced contents, and therefore, duplicated reproducing of stream data can be managed/controlled by the contents receiving unit.

Also, when a discrimination result outputting section 306 is provided as in the contents receiving unit 300 of FIG. 3, a user can select whether or not reproduced stream data is to be re-received for reproducing.

### Embodiment 7

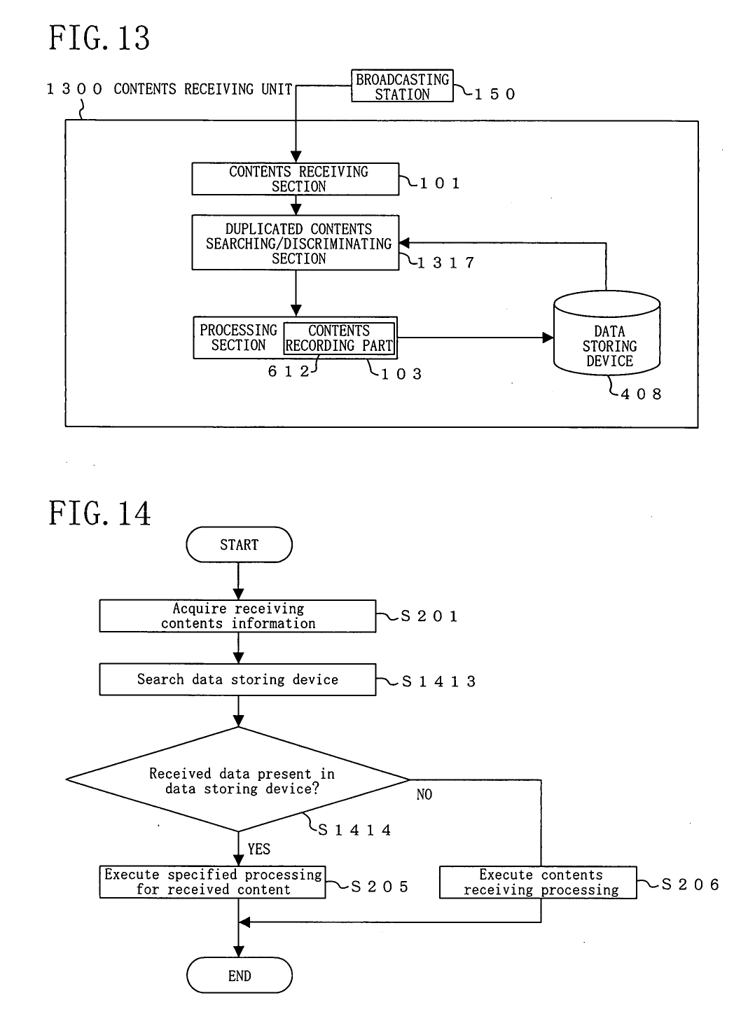

FIG. 13 is a block diagram for showing the whole architecture of a contents receiving unit according to Embodiment 7.

As shown in FIG. 13, the contents receiving unit 1300 includes a contents receiving section 101, a duplicated contents searching/discriminating section 1317, a processing section 103 having a contents recording part 612, and a data storing device 408.

The contents receiving section 101 receives contents from a broadcasting station 150, and the contents recording part 612 records the contents received by the contents receiving section 101 in the data storing device 408.

The duplicated contents searching/discriminating section 1317 searches recorded contents in the data storing device 408 so as to determine whether or not content to be newly received for recording by the contents receiving section 101 accords with any of previously recorded contents.

The processing section 103 executes processing on the content to be newly received for recording by the contents receiving section 101 in accordance with the discrimination result obtained by the duplicated contents searching/discriminating section 1317. When it is determined by the duplicated contents searching/discriminating section 1317 that the content accords with any of previously recorded contents, the processing section 103 terminates the receipt of the content to be newly received for recording.

FIG. 14 is a flowchart of processing performed in the contents receiving unit 1300 of this embodiment.

First, the contents receiving section 101 acquires contents information of content to be received for recording (receiving contents information) (step S201). Next, on the basis of the receiving contents information, the duplicated contents searching/discriminating section 1317 searches the data storing device 408 for contents (step S1413), so as to determine whether or not the content to be received for recording has been already stored in the data storing device 408 (step S1414).

In the procedures of steps S1413 and S1414, information of recorded contents stored in the data storing device 408 is compared with the receiving contents information, and in this comparison, a program title, a content ID, a file size of a content file, a file name of a content file or the like is used. Also, the content to be newly received for recording is determined to accord with previously recorded content when a part of the contents information accords with each other or when at least one of words included in the content information, such as a program title, accords with each other.

In the case where it is determined by the duplicated contents searching/discriminating section 1317 that the content to be newly received for recording by the contents receiving section 101 is present in the data storing device 408 (step S1414), the processing section 103 executes specified processing for recorded content (step S205). In this specified processing, for example, the discrimination result obtained by the duplicated contents searching/discriminating section 1317 is output to an outputting device, or the receipt of the content by the contents receiving section 101 is terminated. Also, as shown in FIG. 3, a discrimination result outputting section 306 may output, to an outputting device 307, the discrimination result obtained by the duplicated contents searching/discriminating section 1317 or a screen for selecting whether or not the receipt is terminated, so that a user can select whether or not the receipt is terminated.

In the case where it is determined by the duplicated contents searching/discriminating section 1317 that the content to be newly received for recording is not present in the data storing device 408 (step S1414), the receiving processing for the content is executed, so that the contents recording part 612 can record the content in the data storing device 408 (step S206).

Furthermore, if there occurs interruption such as power off or processing termination, such a series of contents receiving processing is ended.

In this manner, according to this embodiment, even in the case where contents information of contents previously received and recorded is not stored in the contents receiving unit 1300, it is determined whether or not content to be newly received for recording by the contents receiving section 101 accords with any of previously recorded contents by directly searching recorded contents stored in the data storing device 408. When it is determined to accord with any recorded content, the new receipt is terminated. Therefore, the duplication of received contents can be managed/controlled by the contents receiving unit, namely, on the side of a user.

Furthermore, the contents receiving unit 1300 may be connected to a data storing device such as a hard disk, a disk medium, a memory or a tape device, in which contents received by a device other than the contents receiving unit 1300 are stored, so as to search also the contents stored in this data storing device. Thus, it can be determined whether or not content to be newly received for recording is present in the data storing device, and therefore, the duplication of received contents can be more definitely managed/controlled on the side of a user.

The processing operation of the contents receiving unit of this embodiment may be realized by using software, and the software may be delivered through software download or by using a recording medium such as a CD-ROM.

### Embodiment 8

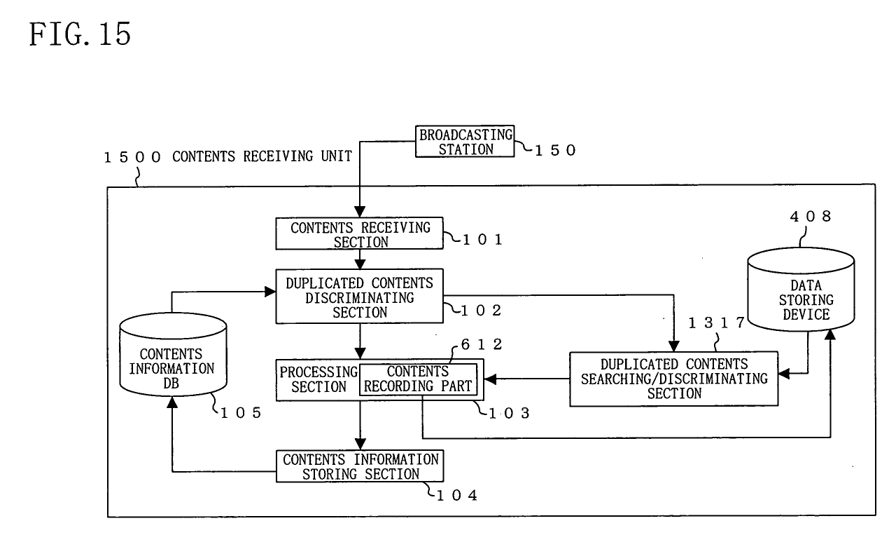

FIG. 15 is a block diagram for showing the whole architecture of a contents receiving unit according to Embodiment 8 of the invention.

As shown in FIG. 15, the contents receiving unit 1500 includes a contents receiving section 101, a duplicated contents discriminating section 102, a processing section 103, a contents information storing section 104, a contents information DB 105, a data storing device 408 and a duplicated contents searching/discriminating section 1317. The composing elements of the contents receiving unit 1500 of this embodiment are the same as those of Embodiments 1 and 7, and hence the description is omitted.

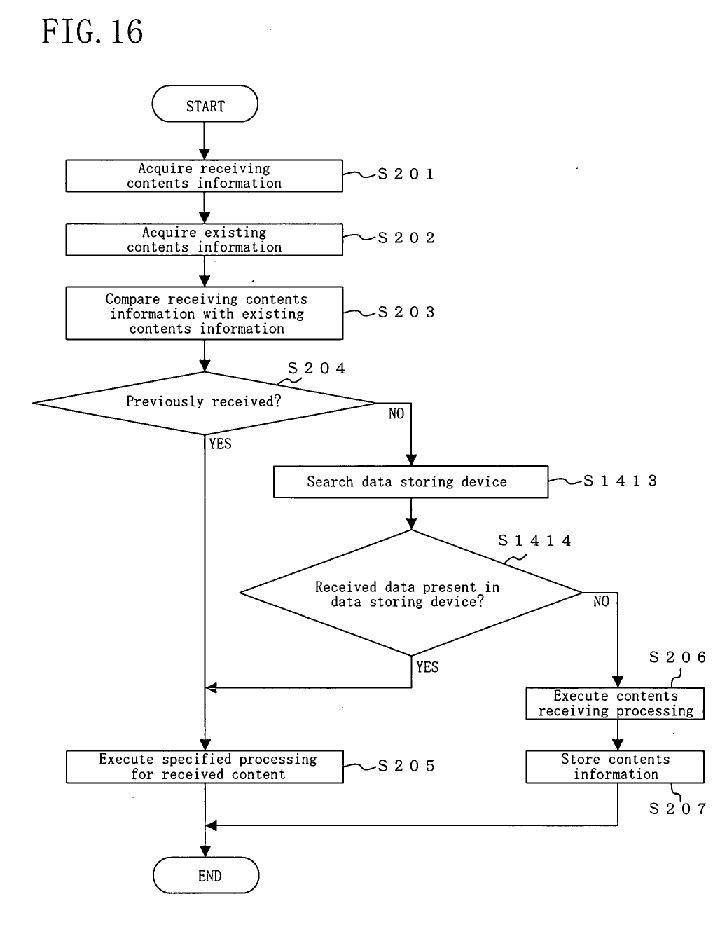

FIG. 16 is a flowchart of processing performed in the contents receiving unit 1500 of this embodiment.

First, the contents receiving section 101 acquires contents information of content to be received (receiving contents information) (step S201). Next, the duplicated contents discriminating section 102 acquires contents information of previously received contents (existing contents information) from the contents information DB 105 (step S202) and compares the receiving contents information and the existing contents information (step S203).

In the comparison of the contents information performed by the duplicated contents discriminating section 102 in step S203, a program title of a delivered program, a content ID, a file size of a content file, a file name of a content file, or the like is used. Specifically, in the case where a part of the receiving contents information accords with a part of the existing contents information or in the case where at least one of words included in the contents information, such as words included in the program title, accords with each other, it is determined that the content to be newly received accords with previously received content.

When it is determined by the duplicated contents discriminating section 102 that the content to be newly received by the contents receiving section 101 accords with any of previously received contents (step S204), the processing section 103 executes specified processing for received content (step S205).

In this specified processing, for example, the discrimination result obtained by the duplicated contents discriminating section 102 is output to an output device, or the receipt of the content by the contents receiving section 101 is terminated. Alternatively, as shown in FIG. 3, the contents receiving unit 1500 may further include a discrimination result outputting section 306 for outputting, to an outputting device 307, the discrimination result obtained by the duplicated contents discriminating section 102 or a screen for selecting whether or not the receipt is terminated, so that a user can select whether or not the receipt is terminated.

In the case where it is determined by the duplicated contents discriminating section 102 that the content to be newly received does not accord with any of previously received contents (step S204), the duplicated contents searching/discriminating section 1317 searches the contents stored in the data storing device 408 on the basis of the receiving contents information (step S1413), so as to determine whether or not the content to be received has been already stored in the data storing device 408 (step S1414).

In the procedures of steps S1413 and S1414, the information of the contents stored in the data storing device 408 and the receiving contents information are compared with each other, and in this comparison, a program title, a content ID, a file size of a content file, a file name of a content file, or the like is used. Specifically, in the case where a part of the contents information accords with each other or in the case where at least one or more of words included in the contents information, such as words included in the program title, accords with each other, it is determined that the content to be newly received for recording accords with previously recorded content.

When it is determined by the duplicated contents searching/discriminating section 1317 that the content to be newly received is present in the data storing device 408 (step S1414), the processing section 103 executes the specified processing for received content (step S205). In this specified processing, for example, the discrimination result obtained by the duplicated contents searching/discriminating section 1317 is output to an output device, or the receipt of the content by the contents receiving section 101 is terminated. Alternatively, as shown in FIG. 3, the contents receiving unit 1500 may further include a discrimination result outputting section 306 for outputting, to an outputting device 307, the discrimination result obtained by the duplicated contents searching/discriminating section 1317 or a screen for selecting whether or not the receipt is terminated, so that a user can select whether or not the receipt is terminated.

When it is determined by the duplicated contents searching/discriminating section 1317 that the content to be newly received for recording is not present in the data storing device 408 (step S1414), the receiving processing for the content is executed, and the contents recording part 612 records the content in the data storing device 408 (step S206). Thereafter, the contents information storing section 104 stores the contents information of the newly received content in the contents information DB 105 (step S207).

If there occurs interruption such as power off or processing termination, such a series of contents receiving processing is ended.

In this manner, according to this embodiment, in the case where contents information of previously received contents is stored in the contents receiving unit 1500, the contents information is used for determining whether or not content to be newly received accords with any of received contents, and in the case where the contents information of previously received contents is not stored in the contents receiving unit 1500, recorded contents stored in the data storing device 408 is directly searched so as to determine whether or not content to be newly received accords with any of previously recorded (received) contents. Therefore, no matter whether contents information of previously received contents is stored in the contents receiving unit 1500, the duplication of received contents can be managed/controlled on the side of a user.

The processing operation performed in the contents receiving unit of this embodiment may be realized by using software, and the software may be distributed through software download or by using a recording medium such as a CD-ROM.

### Embodiment 9

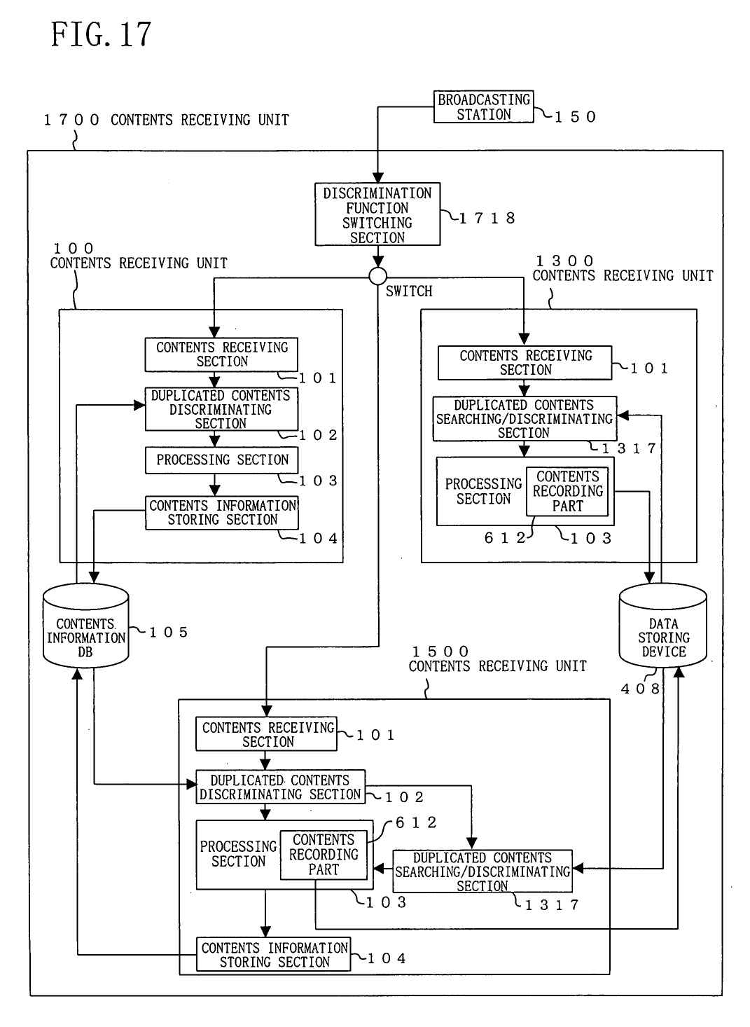

FIG. 17 is a block diagram for showing the whole architecture of a contents receiving unit according to Embodiment 9 of the invention.

As shown in FIG. 17, the contents receiving unit 1700 is obtained by combining the contents receiving unit 100 of Embodiment 1 shown in FIG. 1, the contents receiving unit 1300 of Embodiment 7 shown in FIG. 13 and the contents receiving unit 1500 of Embodiment 8 shown in FIG. 15, and further includes a discrimination function switching section 1718.

The discrimination function switching section 1718 switches a discrimination function among the contents receiving units 100, 1300 and 1500 by selecting one of the contents receiving unit 100, the contents receiving unit 1300 and the contents receiving unit 1500.

Now, the processing operation of the contents receiving unit 1700 of this embodiment will be described with reference to FIG. 17.

First, a user is made to select one of the three contents receiving units 100, 1300 and 1500 included in the contents receiving unit 1700, so as to switch the discrimination function switching section 1718.

Since the three contents receiving units 100, 1300 and 1500 are switched to be used, a user can select a contents receiving unit, for example, having a high search hit ratio or requiring a short search time in accordance with the conditions.

When the discrimination function switching section 1718 switches the contents receiving unit to be used, the contents receiving section 101 included in the selected contents receiving unit acquires contents information of content to be newly received. The operation performed thereafter is the same as that described in Embodiment 1, 7 or 8, and hence the description is omitted.

In this manner, according to this embodiment, the three contents receiving units 100, 1300 and 1500 are provided, and therefore, in accordance with a desired object, such as a high comparison rate or comparison with all contents previously stored, one of the contents receiving unit 100 capable of determining whether or not contents information of content to be received is present in the contents information DB 105, the contents receiving unit 1300 capable of determining whether or not content to be received is present in the data storing device 408 and the contents receiving unit 1500 having both of these functions can be selectively employed.

Needless to say, in the contents receiving unit 1700 of this embodiment, one of the contents receiving units 100, 1300 and 1500 may be selected by a user himself/herself or may automatically switched by the contents receiving unit 1700.

The processing operation performed in the contents receiving unit of this embodiment may be realized by using software, and the software may be delivered through software download or by using a recording medium such as a CD-ROM.

In this manner, according to the contents receiving unit of this invention, duplication of contents to be acquired is discriminated by the contents receiving unit, and hence, even in the case where contents are acquired through a plurality of providers, the CS or CATV and the Peer-to-Peer network, a user can manage/control the duplication of contents to be acquired.

In each of the aforementioned embodiments, each processing or each function may be realized through centralized processing performed by a single device or through distributed processing performed by a plurality of devices.

Moreover, when any of the aforementioned contents receiving units is provided in a picture recording unit, a reproducing unit or a receiving unit, the duplication of contents to be acquired by a user can be managed/controlled also in the picture recording unit, the reproducing unit or the receiving unit.

As described so far, according to the present invention, it is determined by the contents receiving unit whether or not content to be newly received has been previously acquired, and hence, the invention is particularly useful for a picture recording unit, a reproducing unit, a receiving unit and the like.

What is claimed is:

1. A contents receiving unit comprising:
a contents receiving section for receiving contents;
contents information storing section for storing contents information of contents received by said contents receiving section;
a duplicated contents discriminating section for determining whether or not content to be newly received by said contents receiving section accords with any of previously received contents by referring to said contents information stored in said contents information storing section; and
a processing section for executing processing on said content to be newly received in accordance with a discrimination result obtained by said duplicated contents discriminating section.

2. The contents receiving unit of claim 1,
wherein content to be received by said contents receiving section is a program delivered from the outside of said contents receiving unit and said contents information is a program title of said program, and
said duplicated contents discriminating section determines whether or not said content to be newly received by said contents receiving section accords with any of previously received contents on the basis of said program title.

3. The contents receiving unit of claim 1,
wherein said contents information is a content ID provided to each content, and
said duplicated contents discriminating section determines whether or not said content to be newly received by said contents receiving section accords with any of previously received contents on the basis of said content ID.

4. The contents receiving unit of claim 1,
wherein said contents information is a file size of a content file for holding each content, and
said duplicated contents discriminating section determines whether or not said content to be newly received by said contents receiving section accords with any of previously received contents on the basis of said file size.

5. The contents receiving unit of claim 1,
wherein said contents information is a file name of a content file for holding each content, and
said duplicated contents discriminating section determines whether or not said content to be newly received by said contents receiving section accords with any of previously received contents on the basis of said file name.

6. The contents receiving unit of claim 1,
wherein said processing section includes a discrimination result outputting part for outputting the discrimination result obtained by said duplicated contents discriminating section.

7. The contents receiving unit of claim 1, further comprising a picture recording accepting section for accepting instruction of picture recording reservation or picture recording,
wherein said processing section includes a picture recording part for recording content received by said contents receiving section in accordance with the instruction of picture recording reservation or picture recording accepted by said picture recording accepting section,
said contents information storing section stores contents information of content recorded by said picture recording part, and
said duplicated contents discriminating section determines whether or not content for which an instruction of reservation or picture recording is accepted by said picture recording section accords with any of previously recorded contents by referring to the contents information stored in said contents information storing section.

8. The contents receiving unit of claim 1, further comprising a picture recording accepting section for accepting instruction of picture recording reservation or picture recording,
wherein said processing section includes a picture recording part for recording content received by said contents receiving section in accordance with the instruction of picture recording reservation or picture recording accepted by said picture recording accepting section,
said contents information storing section stores contents information of content recorded by said picture recording part, and
said duplicated contents discriminating section determines whether or not content to be newly recorded by said picture recording part accords with any of previously recorded contents by referring to the contents information stored in said contents information storing section.

9. The contents receiving unit of claim 1, further comprising a picture recording accepting section for accepting instruction of picture recording reservation or picture recording,
wherein said processing section includes a picture recording part for recording content received by said contents receiving section in accordance with the instruction of picture recording reservation or picture recording accepted by said picture recording accepting section,
said contents information storing section stores contents information of content recorded by said picture recording part, and
said duplicated contents discriminating section determines whether or not content for which an instruction of reservation or picture recording is accepted by said picture recording section accords with any of contents previously reserved for recording by referring to the contents information stored in said contents information storing section.

10. The contents receiving unit of claim 1,
wherein when content is received, said contents receiving section downloads a content file holding said content.

11. The contents receiving unit of claim 10,
wherein when said contents receiving section re-downloads a content file previously downloaded, said duplicated contents discriminating section determines that said content file accords with a previously downloaded content file even if said content file is to be stored in a different location from the previously downloaded content file, and
said processing section outputs a discrimination result that said content file has been previously downloaded.

12. The contents receiving unit of claim 1,
wherein when it is determined by said duplicated contents discriminating section that content to be newly received by said contents receiving section accords with any of previously received or previously recorded contents, said processing section terminates receipt or picture recording of said content to be newly received by said contents receiving section.

13. The contents receiving unit of claim 1,
wherein when it is determined by said duplicated contents discriminating section that content to be newly received by said contents receiving section accords with any of previously received or previously recorded contents, said processing section outputs a screen for selecting whether or not receipt or picture recording of said content to be newly received by said contents receiving section is terminated, and when termination is selected on the screen, said processing section terminates receipt or picture recording of said content to be newly received by said contents receiving section.

14. The contents receiving unit of claim 1, further comprising a delete discriminating section for determining, when it is determined by said duplicated contents discriminating section that content to be newly received by said contents receiving section accords with any of previously received or previously recorded contents, whether or not the previously received or recorded content has been deleted from said contents receiving unit,
wherein said processing section executes receipt or picture recording of said content to be newly received when said delete discriminating section determines that the received or recorded content has been deleted.

15. The contents receiving unit of claim 1, further comprising a data retrieving section for retrieving, when it is determined by said duplicated contents discriminating section that content to be newly received by said contents receiving section accords with any of previously received or previously recorded contents, previously received or recorded content stored in said contents receiving unit,
wherein said processing section includes a data executing part for reproducing or executing the content retrieved by said data retrieving section.

16. The contents receiving unit of claim 1,
wherein contents received by said contents receiving section are stream data,
said processing section includes a contents reproducing part for reproducing said stream data,
said contents information storing section stores contents information of contents reproduced by said contents reproducing section, and
said duplicated contents discriminating section determines whether or not content to be newly received by said contents receiving section accords with any of previously reproduced contents by referring to the contents information stored in said contents information storing section.

17. The contents receiving unit of claim 1,
wherein said duplicated contents discriminating section determines that content to be newly received or newly recorded accords with any of previously received or previously recorded contents when a part of information specifying said content to be newly received or newly recorded accords with a part of the contents information stored in said contents information storing section.

18. The contents receiving unit of claim 1,
wherein said duplicated contents discriminating section determines that content to be newly received or newly recorded accords with any of previously received or previously recorded contents when at least one of words included in information specifying said content to be newly received or newly recorded accords with a part of the contents information stored in said contents information storing section.

19. A picture recording unit comprising the contents receiving unit of claim 1.

20. A reproducing unit comprising the contents receiving unit of claim 1.

21. A receiving unit comprising the contents receiving unit of claim 1.

22. A contents receiving unit comprising:
a contents receiving section for receiving contents;
a contents recording section for recording contents received by said contents receiving section in a data storing device;
a duplicated contents searching/discriminating section for determining whether or not content to be newly received by said contents receiving section accords with any of previously recorded contents by searching contents stored in said data storing device; and
a processing section for executing processing on said content to be newly received in accordance with a discrimination result obtained by said duplicated contents searching/discriminating section.

23. A contents receiving unit comprising a first contents receiving unit and a second contents receiving unit,
said first contents receiving unit including:
a first contents receiving section for receiving contents;
a contents information storing section for storing contents information of contents received by said first contents receiving section;
a duplicated contents discriminating section for determining whether or not content to be newly received by said first content receiving section accords with any of previously received contents by referring to the contents information stored in said contents information storing section; and
a first processing section for executing processing on said content to be newly received in accordance with a discrimination result obtained by said duplicated contents discriminating section, and
said second contents receiving unit including:
a second contents receiving section for receiving contents;
a contents recording section for recording contents received by said second contents receiving section in a data storing device;
a duplicated contents searching/discriminating section for determining whether or not content to be newly received by said second contents receiving section accords with any of previously recorded contents by searching the contents recorded in said data storing device; and
a second processing section for executing processing on said content to be newly received in accordance with a discrimination result obtained by said duplicated contents searching/discriminating section.

24. The contents receiving unit of claim 23, further comprising a discrimination function switching section for selectively switching one of said first contents receiving unit and said second contents receiving unit.
